(19) United States
(12) Patent Application Publication
(10) Pub. No.: US 2025/0139569 A1
(43) Pub. Date: May 1, 2025

(54) SYSTEM FOR TRACKING SUPPLY CHAIN TRANSACTION INFORMATION ON A NO-CODE BASIS

(71) Applicant: YYSOFT CO., LTD., Gyeonggi-do (KR)

(72) Inventors: HONG HYUN YANG, Gyeonggi-do (KR); SUNG YEOL CHOI, Gangwon-do (KR)

(21) Appl. No.: 18/931,217

(22) Filed: Oct. 30, 2024

(30) Foreign Application Priority Data
Nov. 1, 2023 (KR) 10-2023-0148679

(51) Int. Cl. G06Q 10/0833; G06Q 50/04

(52) U.S. Cl. CPC G06Q 10/0833; G06Q 50/04

(57) ABSTRACT

The present disclosure relates to a device and method for tracking supply chain transaction information on a no-code basis. The device for tracking supply chain transaction information on a no-code basis includes a memory that stores at least one instruction, and a processor, in which the at least one instruction is executed by the processor such that at least one piece of event information generated during a manufacturing or distribution process of a product is acquired, each of the acquired at least one piece of event information is interpreted in conformity with a standard for supply chain transaction information, and the interpreted result is reflected in conformity with the standard for supply chain transaction information on a supply chain scenario relating to the product to generate a map for tracking the manufacturing or distribution process of the product.

### CROSS-REFERENCE TO RELATED APPLICATION

This application claims priority to and the benefit of Korean Patent Application No. 2003-0148679, filed on Nov. 1, 2023, the disclosure of which is incorporated herein by reference in its entirety.

### BACKGROUND

### 1. Field of the Invention

The present disclosure relates to a device and method for tracking supply chain transaction information on a no-code basis, and more specifically, to a device and method for tracking supply chain transaction information on a no-code basis that enables tracking of supply chain transaction information for a product on the basis of the GS1 Electronic Product Code Information Services (EPCIS) standard, which is a global standard.

### 2. Discussion of Related Art

The world is working together to build a smart distribution logistics ecosystem through standardized digital transformation with sustainability as the goal. Global Standards 1 (GS1), which is the non-profit international standards organization for distribution and logistics around the world, is at the center of building the smart distribution logistics ecosystem.

GS1 is developing tracking standards and guidelines for rail and sea transportation, and air logistics to improve visibility in history tracking and meet consumer satisfaction in distribution and logistics, and the tracking standards and guidelines can be applied to agricultural products as well as industrial products.

In addition, the ultimate goal of GS1 is to establish documents on standards that enable implementation of history tracking on existing GS1 standards such as a GS1 identification system, 1- and 2-dimensional barcodes, radio frequency identification (RFID), EPCIS & Core Business Vocabulary (CBV), Electronic Data Interchange (EDI), and Global Data Synchronization Network (GDSN), as well as implementation guidelines for various industrial fields.

This GS1 international standard is a standard that will best realize the data industry, which is the core of the 4^{th} industrial revolution era, and its breadth is expanding to include not only transportation and logistics, but also distribution, healthcare, smart factories, and national defense.

Recently, a demand for product trackability has been increasing in various industries for consumer safety.

Therefore, there is a need to develop a technology for recording and managing various types of information generated during a manufacturing and/or distribution process of a product as a history, thereby enabling not only players involved in the manufacturing and/or distribution process, but also consumers who consume the product to quickly and accurately track the history.

Examples of the related art include Korean Registered Patent Publication No. 10-1451683 (Registration Date: Oct. 10, 2014).

### SUMMARY OF THE INVENTION

The present disclosure is directed to providing a device and method for tracking supply chain transaction information on a no-code basis, according to which various types of information generated during a manufacturing and/or distribution process of a product are recorded and managed as a history, thereby enabling not only players involved in the manufacturing and/or distribution process, but also consumers who consume the product to quickly and accurately track the history.

The problems to be solved by the present disclosure are not limited to the problems mentioned above, and other problems that are not mentioned will be clearly understood by those skilled in the art from the description below.

According to an aspect of the present disclosure, there is provided a device for tracking supply chain transaction information on a no-code basis, which includes a memory that stores at least one instruction, and a processor, in which the processor executes the at least one instruction such that at least one piece of event information generated during a manufacturing or distribution process of a product is acquired, each of the acquired at least one piece of event information is interpreted to conform to a standard for predetermined supply chain transaction information, and the interpreted result is reflected in conformity with the standard for predetermined supply chain transaction information on a supply chain scenario relating to the product to generate a map for tracking the manufacturing or distribution process of the product.

According to another aspect of the present disclosure, there is provided a method of tracking supply chain transaction information on a no-code basis, which includes acquiring at least one piece of event information generated during a manufacturing or distribution process of a product, interpreting each of the acquired at least one piece of event information to conform to a standard for predetermined supply chain transaction information, and reflecting the interpreted result in conformity with the standard for predetermined supply chain transaction information on a supply chain scenario relating to the product and generating a map for tracking the manufacturing or distribution process of the product.

According to still another aspect of the present disclosure, there is further provided a computer program that is stored in a computer-readable recording medium for causing the method for implementing the present disclosure to be executed.

According to yet another aspect of the present disclosure, there is further provided a computer-readable recording medium that records the computer program for causing the method for implementing the present disclosure to be executed.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram showing a structure of an Electronic Product Code (EPC) global network according to an embodiment of the present disclosure;

FIG. 2 is a diagram showing a network structure of a system for tracking supply chain transaction information based on the EPC global network according to an embodiment of the present disclosure;

FIG. 3 is a flowchart showing an operation of the system for tracking supply chain transaction information according to an embodiment of the present disclosure;

FIG. 4 is a diagram showing a configuration of a device for tracking supply chain transaction information according to an embodiment of the present disclosure;

FIG. 5 is a diagram showing a method of tracking supply chain transaction information according to an embodiment of the present disclosure;

FIG. 6 is a diagram showing an example of a supply chain scenario A according to an embodiment of the present disclosure; and

FIG. 7 is a diagram showing an example of a supply chain scenario B according to another embodiment of the present disclosure.

### DETAILED DESCRIPTION OF EXEMPLARY EMBODIMENTS

Hereinafter, embodiments disclosed in this specification will be described in detail with reference to the accompanying drawings, while giving identical or similar components the same reference numbers throughout the drawings and omitting redundant descriptions thereof. The words “module” and “unit” used for components in the following description are given or used interchangeably only for the convenience of writing the specification, and do not have distinct meanings or roles in themselves. In addition, in describing embodiments disclosed in this specification, when it is determined that a specific description of a related known technology may obscure the gist of the embodiments disclosed in this specification, the detailed description thereof will be omitted. In addition, the accompanying drawings are only intended to facilitate easy understanding of the embodiments disclosed in this specification, and the technical ideas disclosed in this specification are not limited by the accompanying drawings, and should be understood to include all modifications, equivalents, and substitutes included in the spirit and technical scope of this disclosure.

Terms including ordinal numbers such as “first,” “second,” etc. may be used to describe various components, but the components are not limited by the terms. The terms are used only for the purpose of distinguishing one component from another component.

When a component is “connected” or “coupled” to another component, it should be understood that the component may be directly connected or coupled to the other component, or another component may be disposed therebetween. On the other hand, when a component is “directly connected” or “directly coupled” to another component, it should be understood that there are no other components therebetween.

In the present application, the terms “include” and “have” are intended to specify the presence of a feature, number, step, operation, component, part, or combination thereof described in the specification, but should be understood not to preclude the presence or addition of one or more other features, numbers, steps, operations, components, parts, or combinations thereof.

In this specification, the term “unit” includes a unit realized by hardware, a unit realized by software, and a unit realized using both. In addition, one unit may be realized by using two or more pieces of hardware, and two or more units may be realized by one piece of hardware.

Some of the operations or functions described as being performed by a terminal, apparatus, or device in this specification may instead be performed by a server connected to the terminal, apparatus, or device. Similarly, some of the operations or functions described as being performed by a server may also be performed by a terminal, apparatus, or device connected to the server.

Although the description in this specification is limited to “a device 100 for tracking supply chain transaction information,” the device is a terminal intended to provide a supply chain transaction information tracking service that enables tracking of a manufacturing or distribution process of a specific product based on a separate platform, and may include various devices capable of performing computational processing. That is, the device 100 for tracking supply chain transaction information may further include a server, a computer, and/or a portable terminal, or may be in the form of any one of a server, a computer, and/or a portable terminal, but is not limited thereto. However, for the convenience of description, the description will be limited to a case where the device 100 for tracking supply chain transaction information is based on a separate platform built to support the supply chain transaction information tracking service. To this end, a separate application or web page may be provided.

Here, examples of the computer may include a notebook, a desktop, a laptop, a tablet PC, a slate PC, etc. equipped with a web browser.

The server is a server that processes information by communicating with an external device, and may include an application server, a computing server, a database server, a file server, a game server, a mail server, a proxy server, a web server, or the like.

The portable terminal is, for example, a wireless communication device that ensures portability and mobility, and may include all kinds of handheld-based wireless communication devices such as Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, Wideband-CDMA (W-CDMA), and Wireless Broadband Internet (WiBro) terminals, smart phones, etc., and wearable devices such as watches, rings, bracelets, anklets, necklaces, glasses, contact lenses, or head-mounted devices (HMDs).

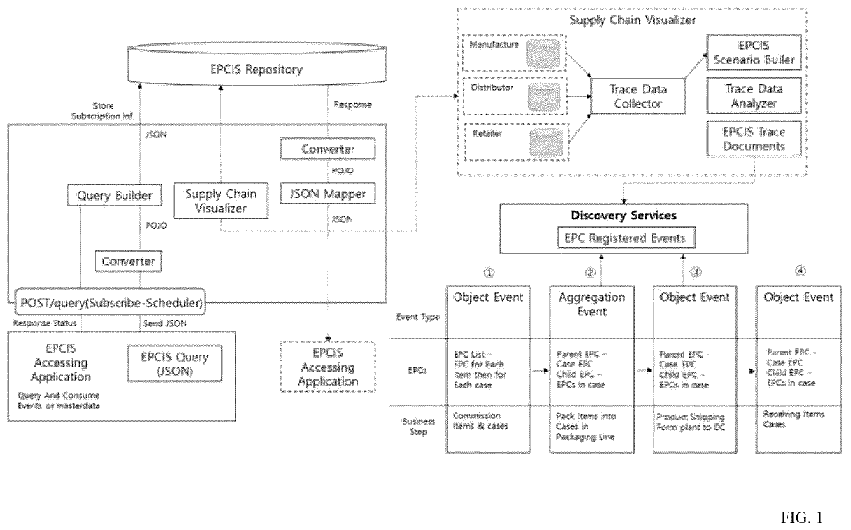

FIG. 1 is a diagram showing a structure of an Electronic Product Code (EPC) global network according to an embodiment of the present disclosure.

Looking at the EPC global network with reference to FIG. 1, the EPC global network is used to allow a product and object to be automatically identified using electronic identification codes such as a radio frequency identification (RFID) tag equipped with the EPC and a reader that can recognize the RFID tag, identified information to be shared through a network such as the Internet, and a location of the product to be tracked, thereby enabling global supply chain management.

Data generated in the EPC global network is primarily provided to stakeholders who need the information and is stored in EPC Information Services (EPCIS) Repository in order to check data.

Among components of an EPCIS system, the EPCIS Repository, which continuously stores and manages a large amount of EPCIS event information (data) input from devices such as numerous RFID terminals at the same time, stores the corresponding EPCIS event information in a database for continuous processing of the large amount of data when multiple processes access the EPCIS Repository at the same time.

The EPCIS provides standardized XML-based Capture & Query Interfaces to enable “Track & Trace” of products even in a global environment with a standardized interface, thereby increasing product visibility. The EPCIS serves as a hub for collecting EPC data for a company. In this disclosure, for this purpose, a module for acquiring event information (Track Data Collector), an event information interpretation module for interpreting the event information (Track Data Analyzer), and/or a module for reflecting the interpreted results on a supply chain scenario of a specific product (EPCIS Scenario Builder) among a plurality of supply chain scenarios (EPCIS Track Documents) may be prepared.

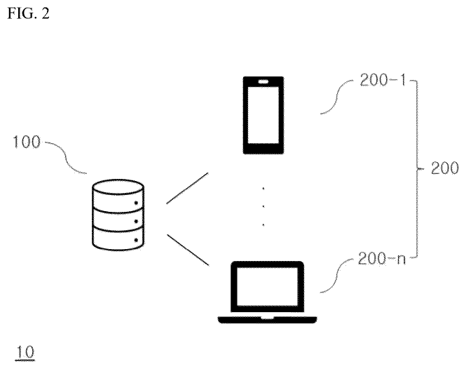

FIG. 2 is a diagram showing a network structure of a system for tracking supply chain transaction information based on the EPC global network according to an embodiment of the present disclosure.

Referring to FIG. 2, a system 10 for tracking supply chain transaction information (hereinafter referred to as a “tracking system”) may include a device 100 for tracking supply chain transaction information (hereinafter referred to as a “tracking device”) and at least one player terminal 200. Here, the tracking device 100 corresponds to the Supply Chain Visualizer of FIG. 1.

First, the tracking device 100 acquires at least one piece of event information generated during a manufacturing or distribution process of a specific product from each of the at least one player terminal 200. Here, the event information includes at least one event input by the player terminal 200 corresponding to the manufacturing or distribution process while going through the manufacturing or distribution process.

That is, the tracking device 100 may acquire the event information by allowing the player terminal 200 of the manufacturing or distribution process to input at least one event that occurred during the manufacturing or distribution process through a separate platform (application or web page).

In addition, the tracking device 100 interprets the at least one piece of event information in conformity with a standard for predetermined supply chain transaction information and reflects the at least one event information on a supply chain scenario relating to a specific product among a plurality of supply chain scenarios, thereby generating a map for tracking the manufacturing or distribution process of the specific product.

Meanwhile, when event information is acquired from each player terminal 200, the tracking device 100 may generate an electronic identification code including the event information. Specifically, the electronic identification code is generated based on event information acquired each time a specific product goes through a manufacturing or distribution process, and in this case, when there is at least one process prior to the manufacturing or distribution process, the electronic identification code includes not only event information for the manufacturing or distribution process but also at least one piece of event information for the process prior to the manufacturing or distribution process. That is, the electronic identification code may be used as a means to fetch a map for a specific product generated by the tracking device 100 or at least one piece of event information included in the map to provide a recent history (including manufacturing, processing, distribution, etc.) for the specific product. In other words, the tracking device 100 may provide a map pointed to by the electronic identification code or at least one piece of event information included in the map as a history.

Here, the electronic identification code may be generated in the form of at least one of an EPC, a quick response (QR) code, and a barcode, and a player, consumer, etc. may receive a production history of a specific product by scanning this electronic identification code. That is, when information about an electronic identification code corresponding to a specific product is acquired from a terminal possessed by a player, consumer, etc. (a player terminal, a consumer terminal, etc.), the tracking device 100 provides a map pointed to by the acquired information or at least one event information included in the map. In this case, information about the electronic identification code may be acquired through scanning or by manually inputting the information, and there is no limitation on the method of acquiring the information.

To this end, the tracking device 100 may provide a separate application or a platform such as a web page for providing such a supply chain transaction information tracking service, as well as an artificial intelligence-based pre-trained model.

Meanwhile, at least one player terminal 200 is a terminal possessed by each player involved (participating) in manufacturing or distribution of a specific product (a company, a user, a manager, a stakeholder, a person in charge, or the like), and each of player terminals 200-1, . . . , 200-n inputs and stores at least one event occurring in a manufacturing or distribution process corresponding to a corresponding player on the platform provided by the tracking device 100, thereby allowing event information to be automatically generated.

In addition, the at least one player terminal 200 may be an Ultra Mobile PC (UMPC), a workstation, a net-book, a PDA, a portable computer, a web tablet, a wireless phone, a mobile phone, a smart phone, a pad, a smart watch, a wearable terminal, an e-book, a portable multimedia player (PMP), a portable game console, a navigation device, a black box, a digital camera, another mobile communication terminal, etc., on which each player may install and execute a plurality of application programs (i.e., applications) desired by the player. That is, the at least one player terminal 200 may be provided in any of various forms, and the form in which the at least one player terminal 200 is provided is not limited.

Meanwhile, although not shown in FIG. 2, the tracking system 10 may further include at least one consumer terminal (not shown). The consumer terminal may scan the electronic identification code generated by the tracking device 100 to receive a map for a specific product corresponding thereto or at least one piece of event information included in the map on the basis of a preset template.

Specifically, a consumer who has purchased a specific product may check a production history thereof in a map for the specific product or at least one piece of event information included in the map visually displayed on a display based on a preset template through a platform provided by the tracking device 100, by scanning an electronic identification code attached to the specific product through a terminal possessed by the consumer.

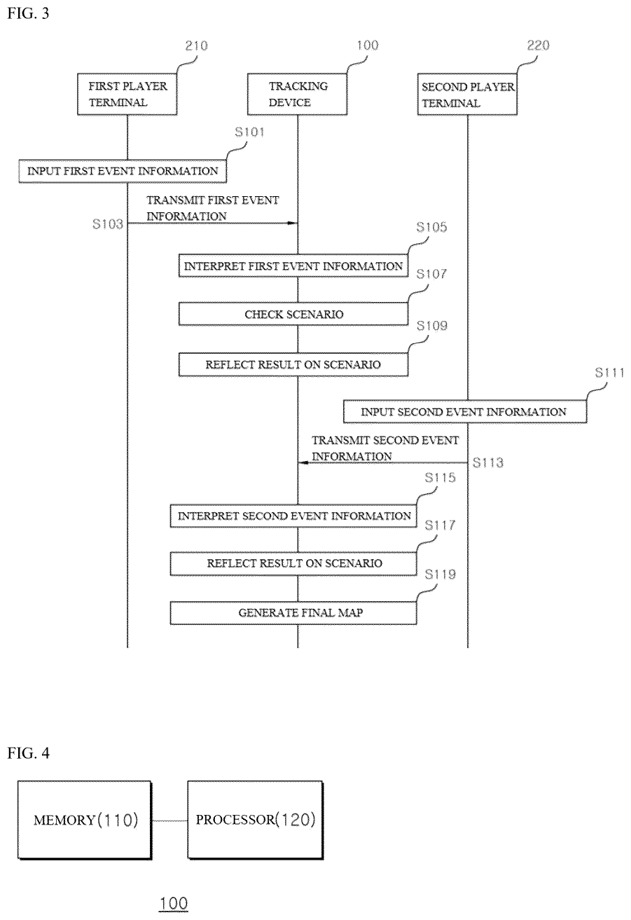

FIG. 3 is a flowchart showing an operation of the system for tracking supply chain transaction information according to an embodiment of the present disclosure, and is limited to a case where a map for a specific product produced through a first manufacturing process by a first player and a second manufacturing process by a second player is generated. However, this is only one example for the convenience of description, and the number of player terminals and each step may be added or omitted depending on a series of production processes and the number of players involved in each production process.

Referring to FIG. 3, when the production of a specific product starts and first event information including at least one event occurring in the first manufacturing process is input on the platform through a first player terminal 210 (S101), the first player terminal 210 involved in the first manufacturing process transmits the input first event information to the tracking device 100 (S103).

Next, the tracking device 100 interprets the first event information received in operation S103 in conformity with a standard for predetermined supply chain transaction information (S105), checks a supply chain scenario relating to the specific product among a plurality of supply chain scenarios (S107), and then reflects the result interpreted in operation S105 on the checked supply chain scenario (S109).

Next, when second event information including at least one event occurring in the second manufacturing process is input on the platform through the second player terminal 220 (S111), the second player terminal 220 involved in the second manufacturing process transmits the input second event information to the tracking device 100 (S113).

Next, the tracking device 100 interprets the second event information received in operation S113 in conformity with a standard for predetermined supply chain transaction information (S115), and reflects the result interpreted in operation S115 on the supply chain scenario relating to the specific product (S117).

Thus, as the entire production process of the specific product is performed, a scenario that reflects all interpreted results for event information of each manufacturing process is generated as a final map (S119).

Meanwhile, although not shown in FIG. 3, when performing operations S109 and S117, the tracking device 100 may generate an electronic identification code in operations S109 and S117.

FIG. 4 is a diagram showing a configuration of a device for tracking supply chain transaction information according to an embodiment of the present disclosure.

Referring to FIG. 4, the device for tracking supply chain transaction information (i.e., the tracking device) 100 according to an embodiment of the present disclosure may include a memory 110 and a processor 120.

The memory 110 may store at least one process (algorithm) for providing a supply chain transaction information tracking service or data for a program that implements the process. In addition, the memory 110 may further store processes for performing other operations and is not limited thereto.

Meanwhile, the memory 110 may store various types of information on at least one product, various types of information on at least one player involved in the production process of each product, as well as a plurality of supply chain scenarios. In addition, the memory 110 may store at least one pre-trained model used for the supply chain transaction information tracking service, and various types of data that support various functions of the tracking device 100, such as templates (forms), equipment, tools, etc. for visually providing the production history for each product.

In addition, the memory 110 may store a plurality of application programs (or applications) driven by the tracking device 100 and data and instructions for the operation of the tracking device 100. At least some of these application programs may be downloaded from an external server through wireless communication. Meanwhile, the application program may be stored in at least one memory provided in the memory 110, installed on the tracking device 100, and driven to cause an operation (or function) to be performed by at least one program stored in the memory 110 through the processor 120.

Meanwhile, the memory 110 may be provided as at least one memory, and may include at least one type of storage medium among a flash memory type medium, a hard disk type medium, a multimedia card micro type medium, a card type memory (e.g., an SD or XD memory, etc.), a magnetic memory of a random access memory (RAM), a static RAM (SRAM), a read-only memory (ROM), an electrically erasable programmable ROM (EEPROM), a programmable ROM (PROM), a magnetic disk, and an optical disc. In addition, the memory may store information temporarily, permanently, or semi-permanently, and may be provided as a built-in or removable type memory.

The memory 110 not only builds an environment in which event information from each player may be shared or integrally managed, but may also be further linked with other separate external servers.

In addition to the operation related to the application program, based on at least one processor, the processor 120 may control all the components in the tracking device 100 to process input or output signals, data, information, etc. or execute instructions, algorithms, and applications stored in at least one memory to perform various processes, and provide or process appropriate information or functions for providing a supply chain transaction information tracking service based on event information from each player.

An operation for providing the supply chain transaction information tracking service is performed by the processor 120 executing at least one instruction stored in the memory 110.

Specifically, when at least one piece of event information generated in each manufacturing or distribution process is acquired from at least one player terminal 200 involved in a manufacturing or distribution process of a specific product, the processor 120 is executed so that each of the acquired at least one piece of event information is interpreted in conformity with a standard for predetermined supply chain transaction information and the interpreted result is reflected in conformity with the standard for predetermined supply chain transaction information mentioned above on a supply chain scenario relating to the product to thereby generate a map for tracking the manufacturing or distribution process of the specific product.

Here, the standard for supply chain transaction information is a convention based on a predetermined grammar, and the supply chain scenario relating to the product is for designing a new supply chain or for monitoring a supply chain of a product already in distribution.

Meanwhile, the event information may include at least one of first information about a received item, second information about a shipped item, and third information about an action that occurred between the received item and the shipped item, with respect to each of the players constituting a supply chain of the product.

In this case, the processor 120 executes the at least one instruction to process the first information, the second information, and the third information provided from each of the players involved in the manufacturing or distribution process in conformity with the standard for supply chain transaction information and then performs an interpretation of each of the acquired at least one piece of event information.

Meanwhile, the processor 120 may acquire event information from each of the players for each production process of the corresponding product. Here, each piece of event information may be generated differently depending on a type of the production process, that is, an event type.

In addition, the processor 120 executes at least one instruction to perform control so that whether a quantity of items shipped from a parent player matches a quantity of items received by the child player between players connected as the parent player and the child player among the players is investigated when the result interpreted based on each piece of event information is reflected in the supply chain scenario for the product. For example, the quantity of items shipped from a parent player may be checked through the second information included in the event information input by the parent player, and the quantity of items received by a child player can be checked through the first information included in the event information input by the child player.

As an embodiment, in at least one of the players, items being received may be received from at least two parent players, or items being shipped may be shipped to at least two child players.

Meanwhile, although not shown in FIG. 4, as shown in FIG. 1, the tracking device 100 may be provided with a module for interpreting the acquired event information (Track Data Analyzer) so that the module may operate based on a grammar without a user handling for the grammar, or a module for reflecting the interpreted result on a scenario of a specific product (EPCIS Scenario Builder) among a plurality of supply chain scenarios (EPCIS Track Documents). In addition, a module for acquiring event information (Track Data Collector) from each of at least one player terminal 200 involved in the manufacturing or distribution process of the specific product may also be provided.

Meanwhile, although not shown in FIG. 4, the tracking device 100 may further include a communication unit.

The communication unit transmits and receives at least one piece of information or data to and from at least one device/terminal. Here, the at least one device/terminal may be a device/terminal that allows the inspection results to be received from the tracking device 100, and the type and form thereof are not limited.

In addition, this communication unit may perform communication with other devices, and transmits and receives wireless signals in a communication network based on wireless Internet technologies.

Examples of wireless Internet technologies include Wireless LAN (WLAN), Wireless-Fidelity (Wi-Fi), Wi-Fi Direct, Digital Living Network Alliance (DLNA), WiBro, World Interoperability for Microwave Access (WiMAX), High Speed Downlink Packet Access (HSDPA), High Speed Uplink Packet Access (HSUPA), Long Term Evolution (LTE), LTE-Advanced (LTE-A), etc., and the tracking device 100 transmits and receives data based on at least one wireless Internet technology, including Internet technologies not listed above.

Wireless Internet technologies for short range communication include Bluetooth™, RFID, Infrared Data Association (IrDA), Ultra Wideband (UWB), ZigBee, Near Field Communication (NFC), Wi-Fi, Wi-Fi Direct, and Wireless Universal Serial Bus (USB) technologies, and short range communications may be supported using at least one of these technologies. These short range wireless communication networks may support wireless communication between the tracking device 100 and at least one terminal. Here, the short range wireless communication network may be a short range wireless personal area network (WPAN).

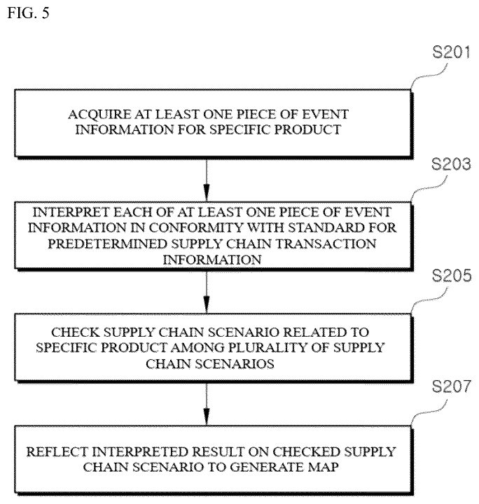

FIG. 5 is a diagram showing a method of tracking supply chain transaction information according to an embodiment of the present disclosure.

Referring to FIG. 5, the tracking device 100 acquires at least one event generated during a manufacturing or distribution process for a specific product from each of at least one player terminal 200 involved in the manufacturing or distribution process (S201). That is, operation S201 may be performed each time the manufacturing or distribution process is repeated while the specific product is produced.

Next, the tracking device 100 interprets each of at least one piece of event information acquired in operation step S201 in conformity with a standard for predetermined supply chain transaction information (S203), checks a supply chain scenario related to the specific product among a plurality of previously stored supply chain scenarios (S205), and then reflects the result interpreted in operation S203 on the checked supply chain scenario to thereby generate a map for the specific product (S207).

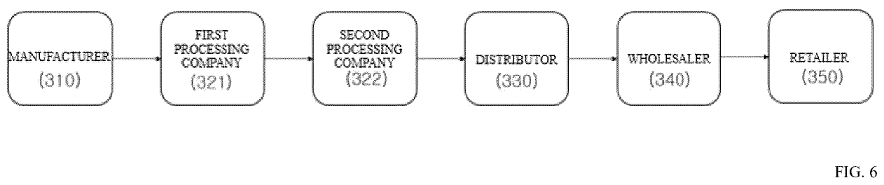

FIG. 6 is a diagram showing an example of a supply chain scenario A according to an embodiment of the present disclosure.

Prior to description, in the supply chain scenario, the ordering, processing (manufacturing), distribution, and sales (wholesale and retail) stages involved in a production process of a specific product are sequentially arranged to form a supply chain.

Referring to FIG. 6, an example of a supply chain scenario A that includes a manufacturer 310, a first processing company 321, a second processing company 322, a distributor 330, a wholesaler 340, and a retailer 350 as players involved in a production process of a specific product is shown.

Specifically, primary processing may be performed by the first processing company 321 based on ordering information of the manufacturer 310, and the primarily processed product may be delivered to the second processing company 322 for secondary processing, delivered to the wholesaler 340 through the distributor 330, and delivered from the wholesaler 340 to the retailer 350. That is, a specific product is produced by sequentially passing through each player, i.e., each company that constitutes the supply chain scenario A. In this case, event information may be entered on the platform by each company as the product passes through each company, and accordingly, an electronic identification code may also be generated.

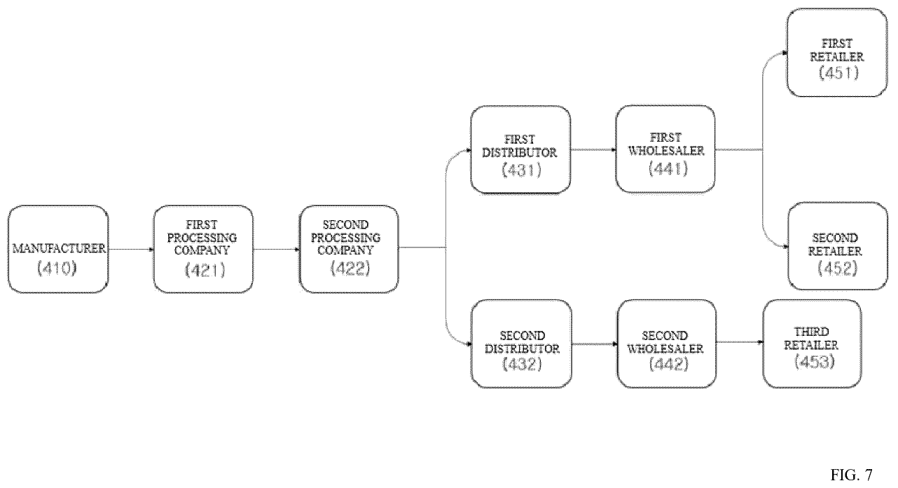

FIG. 7 is a diagram showing an example of a supply chain scenario B according to another embodiment of the present disclosure, and is illustrated to describe a case where a plurality of parent players and/or child players are present.

Referring to FIG. 7, an example of a supply chain scenario B that includes, as players involved in the production process of a specific product, a manufacturer 410, a first processing company 421, a second processing company 422, a first distributor 431, a second distributor 432, a first wholesaler 441, a second wholesaler 442, a first retailer 451, a second retailer 452, and a third retailer 453 is shown.

Specifically, first processing is performed by the first processing company 421 based on order information of the manufacturer 410, the first processed products are delivered to the second processing company 422 for second processing, and then the second processed products are delivered to each of the first distributor 431 and the second distributor 432. Thereafter, some of the products may be delivered to the first wholesaler 441 through the first distributor 431 and then delivered to the first retailer 451 and the second retailer 452. Meanwhile, some of the remaining products among the products may be delivered to the second wholesaler 442 through the second distributor 432 and then delivered to the third retailer 453. Meanwhile, others of the remaining products among the products may be delivered to the second wholesaler 442 through the second distributor 432 and then delivered to the third retailer 453.

Accordingly, child players of the second processing company 422 are the first distributor 431 and the second distributor 432, and thus the second processing company 422 has a plurality of child players.

Meanwhile, although not shown in FIG. 7, in the same way, when the second processing company receives parts produced by two first processing companies to complete one product, the second processing company has a plurality of parent players.

That is, the number of parent players and child players is not limited, and may be set or changed when a manufacturer ordering a specific product designs a supply chain scenario according to a manufacturing plan.

The above-mentioned program may include code coded in a computer language such as C, C++, JAVA, or machine language that can be read by a processor (CPU) of a computer through a device interface of the computer in order to cause the computer to read the program and execute the methods implemented as the program. The code may include functional code related to functions that define functions necessary for executing the methods, and may include control code relating to an execution procedure required to cause the processor of the computer to execute the above functions according to a predetermined procedure. In addition, such code may further include code related to memory reference regarding at which location (address) of an internal or external memory of the computer additional information or media required to cause the processor of the computer to execute the above functions should be referenced. In addition, when the processor of the computer needs to communicate with any other remote computer or server, etc., in order to cause the above functions to be executed, the code may further include communication-related code regarding how to communicate with any other remote computer or server, etc., using a communication module of the computer, and what information or media should be transmitted and received during the communication.

The storage medium is a medium that stores data semi-permanently and can be read by a device, rather than a medium that stores data for a short period of time, such as a register, cache, or memory. Specifically, examples of the storage medium include, but are not limited to, a ROM, a RAM, a CD-ROM, a magnetic tape, a floppy disk, and an optical data storage device. That is, the program may be stored in various storage media on various servers that the computer can access or in various storage media on the user's computer. In addition, the medium may be distributed to computer systems connected to a network and store computer-readable code in a distributed manner.

The steps of the method or algorithm described in relation to embodiments of the present disclosure may be implemented directly on hardware, implemented as a software module executed by hardware, or implemented by a combination thereof. The software module may reside in a RAM, a ROM, an EPROM, an EEPROM, a flash memory, a hard disk, a removable disk, a CD-ROM, or any other form of computer-readable recording medium well known in the art to which the present disclosure pertains.

According to the aspects of the present disclosure, various types of information occurring in the manufacturing and/or distribution process of a product are recorded and managed as a history so that not only players involved in the manufacturing and/or distribution process but also consumers consuming the product can quickly and accurately track the history.

The effects of the present disclosure are not limited to the effects mentioned above, and other effects not mentioned will be clearly understood by those skilled in the art from the description below.

Although embodiments of the present disclosure have been described above with reference to the accompanying drawings, those skilled in the art to which the present disclosure pertains will understand that the present disclosure may be implemented in other specific forms without changing the technical spirit or essential characteristics thereof. Therefore, it should be understood that the embodiments described above are exemplary in all respects and not restrictive.

What is claimed is:

1. A device for tracking supply chain transaction information, comprising:
a memory that stores at least one instruction; and
a processor,
wherein the processor executes the at least one instruction such that:
at least one piece of event information generated during a manufacturing or distribution process of a product is acquired;
each of the acquired at least one piece of event information is interpreted in conformity with a standard for predetermined supply chain transaction information; and
the interpreted result is reflected in conformity with the standard for predetermined supply chain transaction information on a supply chain scenario relating to the product to generate a map for tracking the manufacturing or distribution process of the product,
the standard for supply chain transaction information is a convention based on Extensible Markup Language (XML)-based grammar, and
a module for interpreting the acquired event information or a module for reflecting the interpreted result on the scenario is provided to operate based on the grammar even without a user handling for the grammar.

2. The device of claim 1, wherein the supply chain scenario relating to the product is for designing a new supply chain or for monitoring a supply chain of a product already in distribution.

3. The device of claim 1, wherein the event information includes at least one of first information about a received item, second information about a shipped item, and third information about an action that occurred between the received item and the shipped item, with respect to each of players constituting a supply chain of the product.

4. The device of claim 3, wherein the processor executes the at least one instruction to process the first information, the second information, and the third information provided from each of the players in conformity with the standard for supply chain transaction information and then perform an interpretation of each of the acquired at least one piece of event information.

5. The device of claim 4, wherein the processor executes the at least one instruction to examine whether, when reflecting the interpreted result on the supply chain scenario relating to the product, a quantity of items shipped from a parent player matches a quantity of items received by a child player between players connected as the parent player and the child player among the players.

6. The device of claim 5, wherein, for at least one of the players, items being received are received from at least two parent players, or items being shipped are shipped to at least two child players.

8. The device of claim 1, wherein, when information about an electronic identification code of the product is acquired by the processor executing the at least one instruction, the processor provides a map pointed to by the acquired information or at least one piece of event information included in the map.

9. A method of tracking supply chain transaction information which is performed by a device, the method comprising:
acquiring at least one piece of event information generated during a manufacturing or distribution process of a product;
interpreting each of the acquired at least one piece of event information in conformity with a standard for predetermined supply chain transaction information; and
reflecting the interpreted result in conformity with the standard for predetermined supply chain transaction information on a supply chain scenario relating to the product and generating a map for tracking the manufacturing or distribution process of the product,
wherein the standard for supply chain transaction information is a convention based on Extensible Markup Language (XML)-based grammar, and
a module for interpreting the acquired event information or a module for reflecting the interpreted result on the scenario is provided to operate based on the grammar even without a user handling for the grammar.

10. A computer program that is stored in a computer-readable recording medium for causing the method of tracking supply chain transaction information according to claim 9 to be executed by being combined with a computer which is hardware.
